(19) United States
(12) Patent Application Publication
(10) Pub. No.: US 2023/0325893 A1
(43) Pub. Date: Oct. 12, 2023

(54) Systems & Methods of Matching Consumers with Billing Data

(71) Applicant: Mastercard International Incorporated, New York, NY (US)

(72) Inventors: Sridhar Ramalingam, Wildwood, MO (US); Andrew Buckley, Keniloworth (GB); Genices Batista Inoa, New York, NY (US); David Lau Yi, Stamford, CT (US); Charlotte Ng, Scarsdale, NY (US); Shanthan Subramaniam, Baldwin Place, NY (US)

(21) Appl. No.: 17/718,978

(22) Filed: Apr. 12, 2022

(51) Int. Cl. G06Q 30/04; G06Q 20/40; G06Q 20/14

(52) U.S. Cl. CPC G06Q 30/04; G06Q 20/40; G06Q 20/14

(57) ABSTRACT

According to one implementation of the present disclosure, a method for bill presentment is disclosed. At a computing device associated with a consumer, the computing device having one or more processors, memory, and a display, the method includes: receiving, at a network integrator interface on a digital messaging system, authentication or transaction data from the consumer on the computing device; matching, by the network integrator interface, authentication or transaction data of the consumer with billing data of one or more biller systems associated with the consumer; and providing, by the network integrator interface, the billing data to the consumer.

### BACKGROUND

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

Currently, to a view and/or initiate an electronic bill for payment, consumers have two options. In a first option, a consumer may create and login to each online portal associated with a respective biller to view their bills. Also, generally, to make a payment, the consumer would have to go through the steps of authorizing payment by linking a bank or credit card account at the various biller's websites. Such a process to view and make payment on various bills is often time consuming and requires much effort from the consumer. In a second option, at a consumer's online account of a financial institution (e.g., a bank or credit union), the consumer can set up bill payment for recurring payments. Doing so, however, is often wearisome, challenging, and time-consuming Also, at such financial institutions' online accounts, the consumer may not have the capability to view particular bills. Moreover, whenever the consumer would want to change financial institutions to take advantage of various benefits or services offered at another financial institution, the consumer would have to once again undertake the tedious process of setup requirements and authorizations for bill payment. Hence, there is a need in the art for a less complicated and time-consuming system and methodology for bill presentment and payment.

### SUMMARY

According to one implementation of the present disclosure, a method for bill presentment is disclosed. At a computing device associated with a consumer, the computing device having one or more processors, memory, and a display, the method includes: receiving, at a network integrator interface on a digital messaging system, authentication or transaction data from the consumer on the computing device; matching, by the network integrator interface, authentication or transaction data of the consumer with billing data of one or more biller systems associated with the consumer; and providing, by the network integrator interface, the billing data to the consumer.

According to another implementation of the present disclosure, a chatbot and network integrator computer system is disclosed. The computer system includes a processor; and a memory accessible to the processor, the memory storing instructions that are executable by the processor to perform operations comprising: receiving authentication or transaction data from a consumer on a digital messaging system accessed on a computing device; matching the authentication or transaction data of the consumer with billing data of one or more biller systems associated with the consumer; and providing the billing data to the consumer.

According to another implementation of the present disclosure, a non-transitory computer-readable storage device storing instructions that, when executed by a processor, cause the processor to: receive authentication or transaction data from a consumer (consumer, payor) on a digital messaging system accessed on a computing device; match the authentication or transaction data of the consumer with billing data of one or more biller systems associated with the consumer; and provide the billing data to the consumer.

The above-referenced summary section is provided to introduce a selection of concepts in a simplified form that are further described below in the detailed description section. Additional concepts and various other implementations are also described in the detailed description. The summary is not intended to identify key features or essential features of the claimed subject matter, nor is it intended to be used to limit the scope of the claimed subject matter, nor is it intended to limit the number of inventions described herein. Furthermore, the claimed subject matter is not limited to implementations that solve any or all disadvantages noted in any part of this disclosure.

### BRIEF DESCRIPTION OF THE DRAWINGS

The present technique(s) will be described further, by way of example, with reference to embodiments thereof as illustrated in the accompanying drawings. It should be understood, however, that the accompanying drawings illustrate only the various implementations described herein and are not meant to limit the scope of various techniques, methods, systems, or apparatuses described herein.

FIG. 1 illustrates a diagram in accordance with implementations of various techniques described herein.

FIG. 2 illustrates a display representation in accordance with implementations of various techniques described herein.

FIG. 3 is a particular illustrative aspect of methods in accordance with implementations of various techniques described herein.

FIG. 4 is a block diagram of a computer system in accordance with implementations of various techniques described herein.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

Advantageously, systems, methods, and devices of the present disclosure allow for the capacity of the consumer bypass financial institutions or biller entities (e.g., websites and applications (“apps”) thereof) altogether when desiring to view and/or make payment for bills or invoices for payment. Moreover, schemes and techniques disclosed herein advantageously utilize various application programming interfaces (APIs) to interact directly with consumers and provide flexibility for biller-consumer interaction.

In certain implementations, the inventive aspects may be a “chatbot integrator” (i.e., network integrator interface) that enables a consumer to access one or more payment requests (e.g., a bill, an invoice, etc.) and initiate payment for the one or more payment requests. For instance, the chatbot may be integrated within a mobile messaging application (i.e., “messaging app”), such as iMessage®, Facebook Messenger®, WhatsApp®, GroupMe®, Telegram®, WeChat®, Snapchat®, and/or the like. In particular, the consumer may communicate with the chatbot via the mobile messaging application.

Initially, the chatbot may request for authentication data from the consumer via the messaging application. In response, using the messaging application, the consumer may provide any type of authentication data needed for identity verification to the chatbot. Upon verification of the consumer's identity, the chatbot may match the consumer with associated billers from stored consumer billing data and, display one or more options to view a particular payment request (e.g., a bill, an invoice, etc.) via the messaging application, such as in the form of light bill data (e.g., text information of an invoice) or a Uniform Resource Locator (URL) that links to a full invoice. In certain implementations, the consumer can use the messaging application to choose among one or more payment options to transmit a payment for the particular payment request.

Hence, as certain advantages, inventive schemes and techniques allow for the capability of: 1) matching consumers with associated billers; 2) allowing consumers to view a particular bill (or portions thereof) via the messaging application itself; and 3) allow a consumer to choose from an existing payment method via the messaging application.

Certain definitions are herein provided. For instance, “biller data” or “billing data” may refer to any data associated with bills, invoices, or information pertaining to consumers. Also, a “card” may be defined as any credit or debit card associated with a consumer. Moreover, a “financial institution” may be a be a bank or credit unit that provides account-based banking services to consumers.

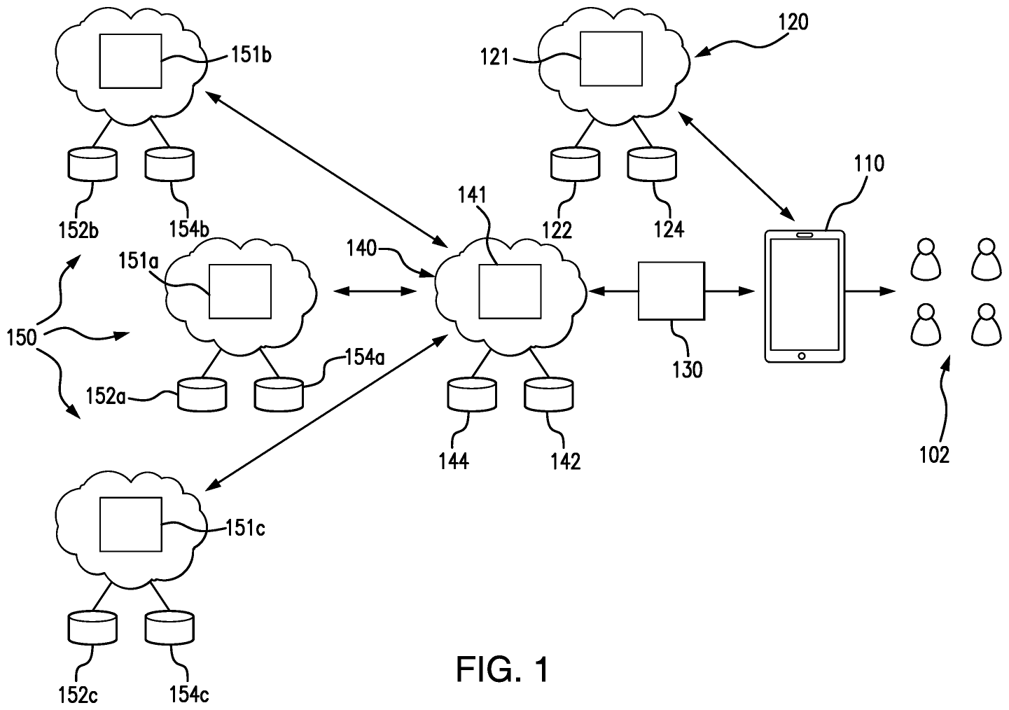

Referring to FIG. 1, an overview of a system 100 is shown according to one implementation. The system 100 may include an electronic device 110 (i.e., a computing device), a messaging system 120 (i.e., a digital messaging system), a network integrator interface 130, and a network aggregator system 140, and a plurality of biller systems 150 (e.g., 150a-150c, etc.).

In certain implementations, through various wireless communication protocols: the electronic device 110 may connect to the messaging system 120 and the network integrator interface 130; the network integrator interface 130 may connect to the network aggregator system 140; and the network aggregator system 140 may connect to one or more of a plurality of biller systems 150 (e.g., 150a-150c, etc.). The wireless communication protocols may include, but are not limited to: wireless communication protocols, such as, Transmission Control Protocol and Internet Protocol (TCP/IP), User Datagram Protocol (UDP), 2^{nd} Generation (2G), 3^{rd} Generation (3G), 4^{th} Generation (4G), 5^{th} Generation (5G) communication protocols, Long Term Evolution (LTE) communication protocols, or any combination thereof.

Also, each of the messaging system 120, the network aggregator system 140, and each of the plurality of biller systems 150 (e.g., 150a-150c, etc.) may include one or more networks. In various implementations, a network may include, without limitation, a local area network (LAN), a wide area network (WAN) (e.g., the Internet), a wireless mobile network, a virtual network, and/or another suitable public and/or private network capable of supporting communication among two or more of the computer system entities or any combination thereof.

The electronic device 110 (i.e., computing device) may include any mobile computer device and/or phone or other computer device. For instance, the electronic device 110 may include a laptop computer, a hand-held computer, phone, or tablet, etc. In various implementations, the electronic device may include one or more processors, memory, and a display for a consumer 102 to interact with the messaging system 120 and the network integrator interface 130.

In various implementations, the electronic device 110 may be coupled to the messaging system 120 and the network integrator interface 130 via the Internet and/or a plurality of local area networks (LANs). As one example, a user 102 (e.g., an owner of the device, a consumer) can utilize the electronic device to communicate with the network integrator interface 130 through the digital messaging system 120.

The messaging system 120 may include an instant messaging application (i.e., “messaging app”) that is stored on one or more networked cloud-based servers 121 and/or networked physical computer systems or servers 122, 124 of the digital messaging system 120. The instant messaging application 120 that is accessible on the electronic device 110 may include, but is not limited to: iMessage® (a registered trademark, and owned and developed by Apple, Inc., Cupertino, CA); Facebook Messenger® (a registered trademark, and owned and developed by Meta, Inc., Menlo Park, CA), WhatsApp Messenger® (a registered trademark, and owned and developed by Meta, Inc., Menlo Park, CA), GroupMe® (a registered trademark, and developed by Skype Communications, Luxembourg, Luxembourg and owned by Microsoft Corp., Redmond, WA), Telegram Messenger® (a registered trademark, and owned and developed by Telegram Messenger, London, United Kingdom) and/or the like. In certain implementations, the messaging application 120 may be a separately installed piece of software (e.g., downloadable app) or browser-based client software on the electronic device 110. In various implementations, the instant messaging application 120 allows for real-time text, audio, and video communication.

In certain implementations, the network integrator interface 130 may be a chatbot or messaging interface that can be accessed by the consumer 102 in the messaging application 120 on the electronic device 110. In various implementations, the network integrator interface 130, through retrieval and authentication of billing data from the network aggregator system 140, enables the consumer 102 to access and/or view one or more payment requests (e.g., bills, invoices, etc.) originating from a biller system 150. The network integrator interface 130 may implement natural language processors and/or artificial intelligence to interact with the consumer 102, and by doing so, the network integrator interface 130 can perform consumer authentication and provide bill presentment and/or payment options. In various implementations, the network integrator interface 130 software may reside on one or more network servers associated with the network aggregator system 140.

The network aggregator system 140 may be securely coupled through networked computers or servers with the network integrator interface 130. The network aggregator system 140 can be on one or more networked cloud-based servers 141 and/or network physical computer systems or servers 142, 144 of the networked aggregator system 140. The network aggregator system 140 may include a collection of application programming interfaces (APIs) that allow for secure transmission and or retrieval of biller data from biller service providers or various billers themselves. In certain implementations, the network aggregator system 140 is configured to enable bill presentment, requests for messaging and payment, and integration with rules and standards related to billers and consumers. For instance, the network aggregator system 140 can provide details into prior transactions (i.e., previous payments to various billers) for identification of billers. Moreover, such a system 140 may provide for different methods of authentication of consumers 102. For instance, the network aggregator system 140 through the chatbot and network integrator interface 130 may prompt the consumer 102 with a particular query such as: Which of following three transactions do you recognize from your most recent card payments? Advantageously, by doing so, the network integrator interface 130 may allow for authentication through criteria such as billing transaction data.

The plurality of biller systems 150 (e.g., 150a-150c, etc.) (i.e., one or more biller systems) may include one or more systems of biller service providers, billers, or associated creditor financial institutions. In certain implementations each of the biller systems may include one or more networked cloud-based servers 151 (e.g., 151a-151c) and/or networked physical computer systems or servers 152, 154 (e.g., 152a-152c, 154-154c) of the biller systems 150. In various implementations, the biller systems 150 may securely transmit billing data to the network aggregator system 140 via API communication. In certain instances, some billers may transmit billing data through batch communication to billing service providers, who in turn would transmit the billing data to the network aggregator system 140.

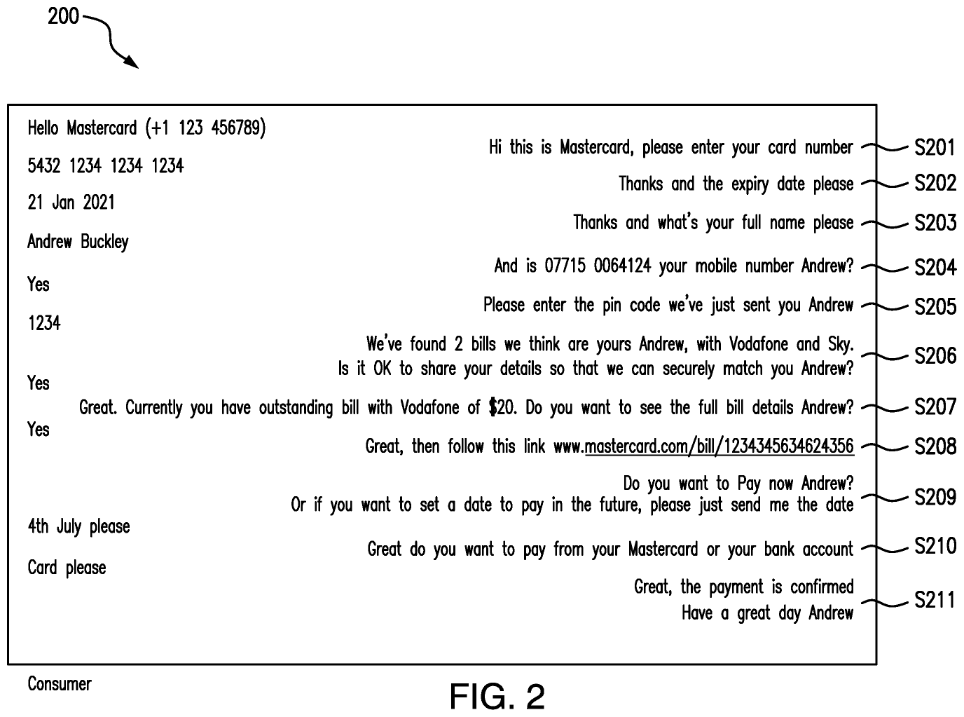

Referring to FIG. 2, an example operation 200 of the network integrator interface 130 is shown. As illustrated, with reference to FIG. 1, the operation 200 may describe a communication between the consumer 102 and the network integrator interface 130.

Initially, a consumer 102 would be prompted to message the inventive network integrator interface 130 (e.g., “Hello Mastercard”) on the computing device 110. In doing so, the computing device 110 may communicate (over communication networks) with the messaging system 120 located (one or more first servers or computer systems) and the network integrator interface 130 (located on one or more second servers or computer systems). In response to the initial communication request, in preliminary steps S201-S203, in one implementation (as shown), the network integrator interface 130 may request that the consumer 102 to provide their card number (associated with an account), expiry date of their card, and full name While in this particular case, the authentication request is for card number, expiry date, and full name, any authentication or transaction data (e.g., phone number, mailing address (i.e., consumer personal data), account number, bill transaction data, last four digits of account number, or any other specific account or card information (e.g., expiration date) may be utilized. In certain implementations, such data may be stored in one or more consumer directories stored on one or more servers or computers systems associated with the network aggregator system 140 or the plurality of billing systems 150. As illustrated, in S204, in one example, in a subsequent request, the network integrator interface 130 can prompt the consumer 102 with their phone number on file (e.g., phone number data stored on one or more servers or computers systems associated with the network aggregator system 140 or the plurality of billing systems 150) and ask if it is correct.

Once confirmed, at step S205, in one example, the consumer 102 may be requested to enter a pin number that was sent by the network integrator interface 130. Once the pin number is confirmed, in one example, at step S206, the network integrator interface 130 may display the quantity of bills or invoices available (e.g., 2 bills), and request permission of the consumer 102 to share consumer authentication data with the one or billing systems 150 to securely match the consumer. In certain implementations, the matching of the consumer 102 with billing data includes determining, by one or more APIs of the network aggregator system 140 whether any invoice details corresponds to the authentication or transaction data of the consumer 102. For example, in certain instances, the network aggregator system 140 through one or more APIs may provide authentication or transaction data to the one or more biller systems 150. Upon doing so, the one or more APIs of the network aggregator system 140 may retrieve billing data (that corresponds to the consumer 102) from the one or more biller systems 150, and transmit the billing data to the network integrator interface 130. Once the consumer 102 is securely matched, at step S207, in one example, brief details such as an amount owed (e.g., $20) can be provided to the consumer 102 via text message, and a subsequent request may be made whether the consumer would like to see the full bill details (e.g.,, bill presentment). For instance, if the consumer 102 replies in the affirmative, at step S208, a Uniform Resource Locator (URL) may be provided by the network integrator interface 130 that links to the full bill or invoice. In certain instances, the full bill or invoice may be stored on one or more secure networks associated with the network aggregator system 140.

At step S209, the chatbot network integrator 130 can allow the consumer 102 different options for payment and timing of payment. For example, as shown, the network integrator interface 130 would ask the consumer whether he or she would like to payment now or if payment should be made on a future date? In response, the consumer 102 may enter the date of payment desired. At step S210, in one example, the network integrator interface 130 may ask whether payment be made from an associated card or from bill payment through a bank account. For such options, advantageously, the network integrator interface 130 may securely connect with the one or more biller systems 150 to enable such transactions. In other alternative options, the network integrator interface 130 can provide options for real-time payment (RTP), mobile wallet, and/or integrate with the messaging system 120 to allow for the consumer to make payment from existing messaging application payment features (e.g., Apple Pay, Facebook Pay, etc.). With respect to RTP transactions, in real-time, the network integrator interface 130 can facilitate confirmation of funds to a particular biller. At step S211, in one example, the chatbot network integrator 130 can confirm payment with consumer. For instance, after receiving payment transaction confirmation data form either messaging system 120 or one or more biller systems 150, the network integrator interface 130 can provide confirmation of payment to the consumer 102.

While S201-S211 provide a somewhat detailed exchange by the network integrator interface 130 and consumer 102, in other examples, a greater number or a fewer number of options may be provided by the network integrator interface 130.

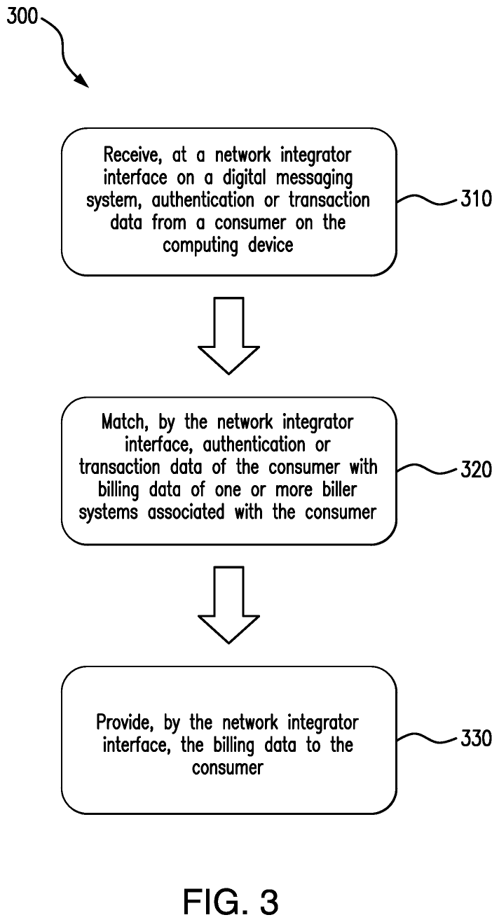

Referring to FIG. 3, a method 300 (e.g., implemented as a network integrator interface 130) for bill presentment according to example implementations is shown. The method 300 includes the following steps at a computing device associated with a consumer, the computing device having one or more processors, memory, and a display.

At block 310, the method 300 includes receiving, at a network integrator interface on a digital messaging system, authentication or transaction data from the consumer on the computing device. For instance, with reference to FIGS. 1 and 2, the network integrator interface 130 (chatbot and network integrator) on a digital messaging system (“messaging app”) 120 may receive authentication or transaction data from the consumer (i.e., payor) 102 on the computing device 110.

At block 320, the method includes matching, by the network integrator interface, the authentication or transaction data of the consumer with billing data of one or more biller systems associated with the consumer. For instance, with reference to FIGS. 1 and 2, the network integrator interface 130 (e.g., chatbot and network integrator) may match the authentication or transaction data of the consumer 102 with billing data of one or more biller systems 150 associated with the consumer 102.

At block 330, the method includes providing, by the network integrator interface, the billing data to the consumer. For instance, with reference to FIGS. 1 and 2, the network integrator interface 130 (e.g., chatbot and network integrator) may provide the billing data to the consumer 102.

In additional steps, the method may include providing, by the network integrator interface, payment transaction authorization data to the digital messaging system or the one or more billing systems. In certain instances, such payment transaction authorization data may include data associated with payment authorization or a scheduled date for payment. For instance, with reference to FIGS. 1 and 2, after receiving a selection of payment by the consumer 102 to allow payment through a card or bank account (from a particular billing system 150) or through messaging payment features of a messaging system, the network integrator interface 130 (chatbot and network integrator) may provide payment transaction authorization data to the digital messaging system 120 or the one or more billing systems 150.

In certain examples, the method may include that in response to payment transaction confirmation data received, providing, by the network integrator interface, confirmation of payment to the consumer. For instance, with reference to FIGS. 1 and 2, the network integrator interface 130 can provide confirmation of payment or scheduled payment to the consumer 102 once the network integrator interface 130 receives confirmation of payment or scheduled payment.

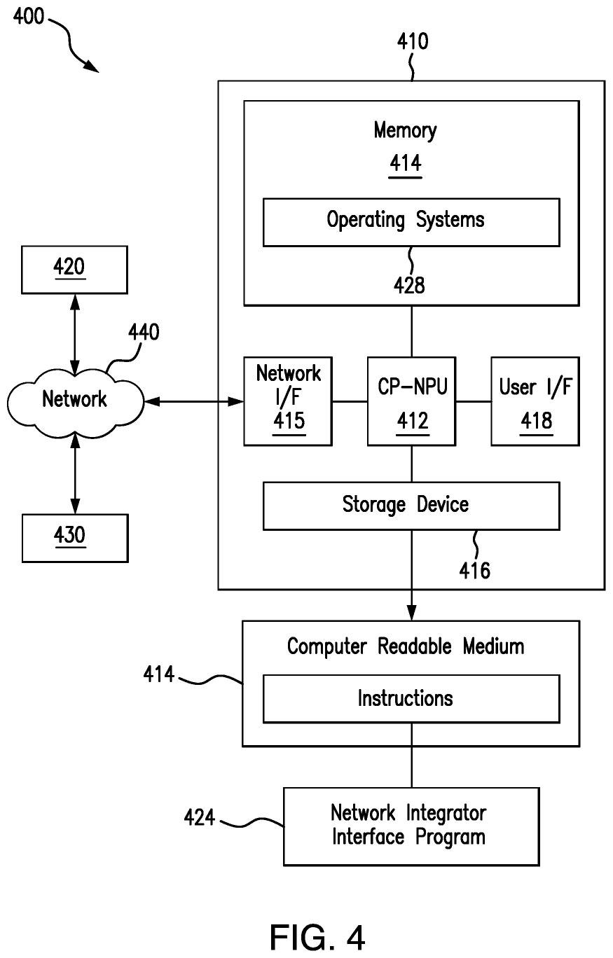

FIG. 4 is a diagram depicting the computer system 400 (e.g., networked computer system and/or server) for the example network integrator interface 130 (as described in FIG. 1), according to one implementation. FIG. 4 illustrates example hardware components in the computer system 400 that may be used to facilitate bill presentment (and payment options in certain implementations) to consumers 102 via a messaging system 120 on a computing device 110. The computer system 400 includes a computer 410 (i.e., chatbot network integration computer), which may be implemented as a server or a multi-use computer that is coupled via a network 440 to one or more networked computers or servers 420, 430. In certain implementations, the computers or serves 420 may correspond to the messaging system 120, while the computers or servers 430 may correspond to one or more billing systems 150. The method 300 may be stored as program code (i.e., network integrator interface program) 424 in memory that may be performed by the computer 410, the computers 420, 430, other networked electronic devices (not shown) or a combination thereof. In some implementations, the network integrator interface program 424 may read input data (e.g., authentication or transaction data; payment transaction authorization data; billing data; payment transaction or scheduling confirmation data) and provide controlled output data to various connected computer systems or servers. In certain implementations, each of the computers 410, 420, 430 may be any type of computer, computer system, or other programmable electronic device. Further, each of the computers 410, 420, 430 may be implemented using one or more networked (e.g., wirelessly networked) computers, e.g., in one or more cluster or other distributed computing systems.

In one implementation, the computer 410 includes a central processing unit (CPU) or neural processing unit (NPU) having at least one hardware-based processor coupled to a memory 414. The memory 414 may represent random access memory (RAM) devices of main storage of the computer 410, supplemental levels of memory (e.g., cache memories, non-volatile or backup memories (e.g., programmable or flash memories)), read-only memories, or combinations thereof. In addition to the memory 414, the computer system 400 may include other memory located elsewhere in the computer 410, such as cache memory in the CPU 412, as well as any storage capacity used as a virtual memory (e.g., as stored on a storage device 416 or on another computer coupled to the computer 410). The memory 414 may include the network integrator interface program 424 to facilitate bill presentment and bill payment options for numerous consumers.

The computer 410 may further be configured to communicate information externally. To interface with a user or operator, the computer 410 may include a user interface (I/F) 418 incorporating one or more user input devices (e.g., a keyboard, a mouse, a touchpad, and/or a microphone, among others) and a display (e.g., a monitor, a liquid crystal display (LCD) panel, light emitting diode (LED), display panel, and/or a speaker, among others). In other examples, user input may be received via another computer or terminal. Furthermore, the computer 410 may include a network interface (I/F) 420 which may be coupled to one or more networks 440 (e.g., a wireless network) to enable communication of information with other computers and electronic devices. The computer 410 may include analog and/or digital interfaces between the CPU 412 and each of the components 414, 416, 418 and 420. Further, other non-limiting hardware environments may be used within the context of example implementations.

The computer 410 may operate under the control of an operating system 426 and may execute or otherwise rely upon various computer software applications, components, programs, objects, modules, data structures, etc. (such as the network integrator interface program 424 and related software). The operating system 426 may be stored in the memory 414. Operating systems include, but are not limited to, UNIX® (a registered trademark of The Open Group), Linux® (a registered trademark of Linus Torvalds), Windows® (a registered trademark of Microsoft Corporation, Redmond, WA, United States), AIX® (a registered trademark of International Business Machines (IBM) Corp., Armonk, NY, United States) i5/OS® (a registered trademark of IBM Corp.), and others as will occur to those of skill in the art. The operating system 426 and the network integrator interface program 424 in the example of FIG. 4 are shown in the memory 414, but components of the aforementioned software may also, or in addition, be stored at non-volatile memory (e.g., on storage device 416 (data storage) and/or the non-volatile memory (not shown). Moreover, various applications, components, programs, objects, modules, etc. may also execute on one or more processors in another computer coupled to the computer 410 via the network 440 (e.g., in a distributed or client-server computing environment) where the processing to implement the functions of a computer program may be allocated to multiple computers over the network 440.

Aspects of the present disclosure may be incorporated in a system, a method, apparatus and/or a computer program product. The computer program product may include a computer-readable storage medium (or media) having computer-readable program instructions thereon for causing a processor to carry out aspects of the present disclosure. The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. For example, the memory 414, the storage device 416, or both, may include tangible, non-transitory computer-readable media or storage devices.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, a special purpose computer, or other programmable data processing apparatus to produce a machine, such that the instructions, which execute via the processor of the computer or other programmable data processing apparatus. The machine is an example of means for implementing the functions/acts specified in the flowchart and/or block diagrams. The computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the functions/acts specified in the flowchart and/or block diagrams.

The computer-readable program instructions may also be loaded onto a computer, other programmable data processing apparatus, or other device to cause a series of operational steps to be performed on the computer, other programmable apparatus or other device to perform a computer implemented process, such that the instructions which execute on the computer, other programmable apparatus, or other device implement the functions/acts specified in the flowchart and/or block diagrams.

The flowchart and block diagrams in the Figures illustrate the architecture, functionality, and operation of possible implementations of systems, methods, and computer program products according to various implementations of the present disclosure. In this regard, each block in the flowchart or block diagrams may represent a module, segment, or portion of instructions, which comprises one or more executable instructions for implementing the specified logical function(s). In some alternative implementations, the functions noted in a block in a diagram may occur out of the order noted in the figures. For example, two blocks shown in succession may be executed substantially concurrently, or the blocks may sometimes be executed in the reverse order, depending upon the functionality involved. It will also be noted that each block of the block diagrams and/or flowcharts, and combinations of blocks in the block diagrams and/or flowcharts, can be implemented by special purpose hardware-based systems that perform the specified functions or acts or carry out combinations of special purpose hardware and computer instructions.

In the following description, numerous specific details are set forth to provide a thorough understanding of the disclosed concepts, which may be practiced without some or all of these particulars. In other instances, details of known devices and/or processes have been omitted to avoid unnecessarily obscuring the disclosure. While some concepts will be described in conjunction with specific examples, it will be understood that these examples are not intended to be limiting.

Unless otherwise indicated, the terms “first”, “second”, etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

Reference herein to “one example” means that one or more feature, structure, or characteristic described in connection with the example is included in at least one implementation. The phrase “one example” in various places in the specification may or may not be referring to the same example.

Illustrative, non-exhaustive examples, which may or may not be claimed, of the subject matter according to the present disclosure are provided below. Different examples of the device(s) and method(s) disclosed herein include a variety of components, features, and functionalities. It should be understood that the various examples of the device(s) and method(s) disclosed herein may include any of the components, features, and functionalities of any of the other examples of the device(s) and method(s) disclosed herein in any combination, and all of such possibilities are intended to be within the scope of the present disclosure. Many modifications of examples set forth herein will come to mind to one skilled in the art to which the present disclosure pertains having the benefit of the teachings presented in the foregoing descriptions and the associated drawings.

Therefore, it is to be understood that the present disclosure is not to be limited to the specific examples illustrated and that modifications and other examples are intended to be included within the scope of the appended claims. Moreover, although the foregoing description and the associated drawings describe examples of the present disclosure in the context of certain illustrative combinations of elements and/or functions, it should be appreciated that different combinations of elements and/or functions may be provided by alternative implementations without departing from the scope of the appended claims. Accordingly, parenthetical reference numerals in the appended claims are presented for illustrative purposes only and are not intended to limit the scope of the claimed subject matter to the specific examples provided in the present disclosure.

What is claimed is:

1. A method comprising:
at a computing device associated with a consumer, the computing device having one or more processors, memory, and a display;
receiving, at a network integrator interface on a digital messaging system, authentication or transaction data from the consumer on the computing device;
matching, by the network integrator interface, authentication or transaction data of the consumer with billing data of one or more biller systems associated with the consumer; and
providing, by the network integrator interface, the billing data to the consumer.

2. The method of claim 1, further comprising:
providing, by the network integrator interface, payment transaction authorization data to the digital messaging system or the one or more billing systems, wherein the payment transaction authorization data comprises data associated with payment authorization or a scheduled date for payment.

3. The method of claim 3, further comprising:
in response to payment transaction or scheduling confirmation data received, providing, by the network integrator interface, confirmation of payment or scheduled payment to the consumer.

4. The method of claim 1, wherein the network integrator interface comprises a messaging interface.

5. The method of claim 4, wherein the network integrator interface is a natural language interface configured for at least one of consumer authentication and bill presentment.

6. The method of claim 1, wherein the authentication or transaction data can be one or more or a combination of a card number data, expiry date data, name data, account number data, bill transaction data, or consumer personal data.

7. The method of claim 1, wherein the network integrator interface is accessed from one or more first servers or networks, and wherein the digital messaging system is accessed from one or more second servers or networks.

8. The method of claim 1, wherein matching the authentication or transaction data of the consumer with the billing data comprises:
providing, by one or more application programming interfaces transmitted by a network aggregator system, the authentication or transaction data to the one or more biller systems;
retrieving, by the one or more application programming interfaces from the one or more biller systems or the network aggregator system, the billing data corresponding to the consumer; and
transmitting the billing data to the network integrator interface.

9. The method of claim 1, wherein providing the billing data to the consumer comprises:
receiving the billing data from a network aggregator system, and
displaying, by the network integrator interface on the digital messaging system accessed on computing device, the billing data retrieved at the computing device.

10. A computer system, comprising:
a processor; and
a memory accessible to the processor, the memory storing instructions that are executable by the processor to perform operations comprising:
receiving authentication or transaction data from a consumer on a digital messaging system accessed on a computing device;
matching the authentication or transaction data of the consumer with billing data of one or more biller systems associated with the consumer; and
providing the billing data to the consumer.

11. The computer system of claim 10, further comprising:
providing payment transaction authorization data to the digital messaging system or the one or more biller systems, wherein the payment transaction authorization data comprises data associated with payment authorization or a scheduled date for payment.

12. The computer system of claim 10, further comprising:
in response to payment transaction or scheduling confirmation data received, providing confirmation of payment or scheduled payment to the consumer.

13. The computer system of claim 10, wherein the computer system comprises a network integrator interface.

14. The computer system of claim 13, wherein the network integrator interface is a natural language interface configured for at least one of consumer authentication and bill presentment.

15. The computer system of claim 13, wherein the network integrator interface is accessed from one or more first servers or networks, and wherein the digital messaging system is accessed from one or more second servers or networks.

16. The computer system of claim 10, wherein the authentication or transaction data can be one or more or a combination of a card number data, expiry date data, name data, account number data, bill transaction data, or consumer personal data.

17. The computer system of claim 10, wherein matching the authentication or transaction data of the consumer with the billing data comprises:
providing, by one or more application programming interfaces of the computer system, the authentication or transaction data to the one or more biller systems;
retrieving, by the one or more application programming interfaces from the one or more biller systems or the network aggregator system, the billing data corresponding to the consumer; and
transmitting the billing data to the computer system.

18. The computer system of claim 10, wherein providing the billing data to the consumer comprises:
receiving the billing data from a network aggregator system, and
displaying, by the network integrator interface on the digital messaging system accessed on computing device, the billing data retrieved at the computing device.

19. The computer system of claim 11, wherein the computer system is communicatively coupled with the one or more biller systems and the messaging system.

20. A non-transitory computer-readable storage device storing instructions that, when executed by a processor, cause the processor to:
receive authentication or transaction data from a consumer on a digital messaging system accessed on a computing device;
match the authentication or transaction data of the consumer with billing data of one or more biller systems associated with the consumer; and
provide the billing data to the consumer.
